(19) United States
(12) Patent Application Publication
(10) Pub. No.: US 2006/0202012 A1
(43) Pub. Date: Sep. 14, 2006

(54) Secure data processing system, such as a system for detecting fraud and expediting note processing

(76) Inventors: David Grano, Tualatin, OR (US); Matthew E. Buhler, Portland, OR (US); J. Milford Ford, Portland, OR (US); Karen Lawson, Hillsboro, OR (US)

Correspondence Address: PERKINS COIE LLP;PATENT-SEA, P.O. BOX 1247, SEATTLE, WA, 98111-1247, US

(21) Appl. No.: 11/258,407

(22) Filed: Oct. 24, 2005

Related U.S. Application Data
(60) Provisional application No. 60/627,327, filed on Nov. 12, 2004.
(60) Provisional application No. 60/704,661, filed on Aug. 1, 2005.
(60) Provisional application No. 60/706,183, filed on Aug. 5, 2005.

(51) Int. Cl. G07F 19/00; G06Q 40/00

(52) U.S. Cl. 235/379; 705/39; 705/45

(57) ABSTRACT

A transaction fraud detection system allows for the processing of documents such as checks in a way that reduces the possibility of fraud. The transaction fraud detection system provides customer enrollment and check enrollment functionality. It applies rules to data collected using the customer enrollment, the check enrollment, and possibly other data sources to determine a risk associated with a transaction, which may include generating a score. The applied rules may be customized via risk modeling functionality. For example, an administrator may be able to custom-select the types of rules to apply, the weighting or value given to any given rule, etc. The risk modeling may be at least partially automated, and may involve self-learning aspects that allow the risk modeling and/or application of rules to be at least partially based on past transactions.

### CROSS-REFERENCE TO RELATED APPLICATION(S)

This application claims priority to U.S. Provisional Patent Application No. 60/627,327, entitled “Check Processing System for Detecting Fraud and Expediting Check Processing,” filed Nov. 12, 2004, U.S. Provisional Patent Application No. 60/704,661, also entitled “Check Processing System for Detecting Fraud and Expediting Check Processing,” and U.S. Provisional Patent Application No. 60/706,183, entitled “Secure Data Processing System, Such as a System for Detecting Fraud and Expedited Note Processing,” filed Aug. 5, 2005, which are all herein incorporated by reference.

### TECHNICAL FIELD

Disclosed embodiments relate to networked data processing systems for providing more secure transactions.

### BACKGROUND

Each month, millions of check holders visit financial institutions, check cashing outlets, and retail stores to cash checks. These check cashers represent potential revenue, potential market share, and unfortunately, potential losses, because of the risks involved with cashing checks. For example, according to the Consumer Banking Association, many of the 42 billion paper checks written each year in the United States are issued to a group of over 25 million people who have a regular source of income, but who do not keep a basic checking account. Commonly referred to as the “unbanked,” this group is also the most frequent source of check fraud in the country. Moreover, by the time check fraud is discovered, it is often too late.

Accordingly, in light of current technologies, check cashing is typically a risky, repetitive, and labor-intensive activity. For example, the Federal Reserve estimates that check fraud costs America $15 billion per year and anticipates continued growth by 5-10% annually. Various systems currently exist that attempt to address such fraud. However, there is a need to improve on such systems and to make them more efficient and less costly to use, as well as provide other benefits.

### BRIEF DESCRIPTION OF THE DRAWINGS

FIG. 1 is a block diagram showing an example of an environment in which aspects of the check cashing facility with fraud detection capabilities may be implemented.

FIG. 2 is a block diagram of the fraud detection engine and associated components of a check cashing facility.

FIG. 3 is a flow diagram showing an overview of check processing in one embodiment.

FIG. 4A is a flow diagram showing an example of a client-side routine for enrolling a new check cashing customer in one embodiment.

FIG. 4B is a flow diagram showing an example of a server-side routine for enrolling a new check cashing customer in one embodiment.

FIG. 5 is a flow diagram showing an example of a routine for enrolling a check in one embodiment.

FIGS. 6A-6C are flow diagrams showing examples of a check analysis routine in some embodiments.

FIG. 7A-13 are display diagrams and data diagrams showing examples of screen shots and other information associated with setting rules and transaction profiles in some embodiments.

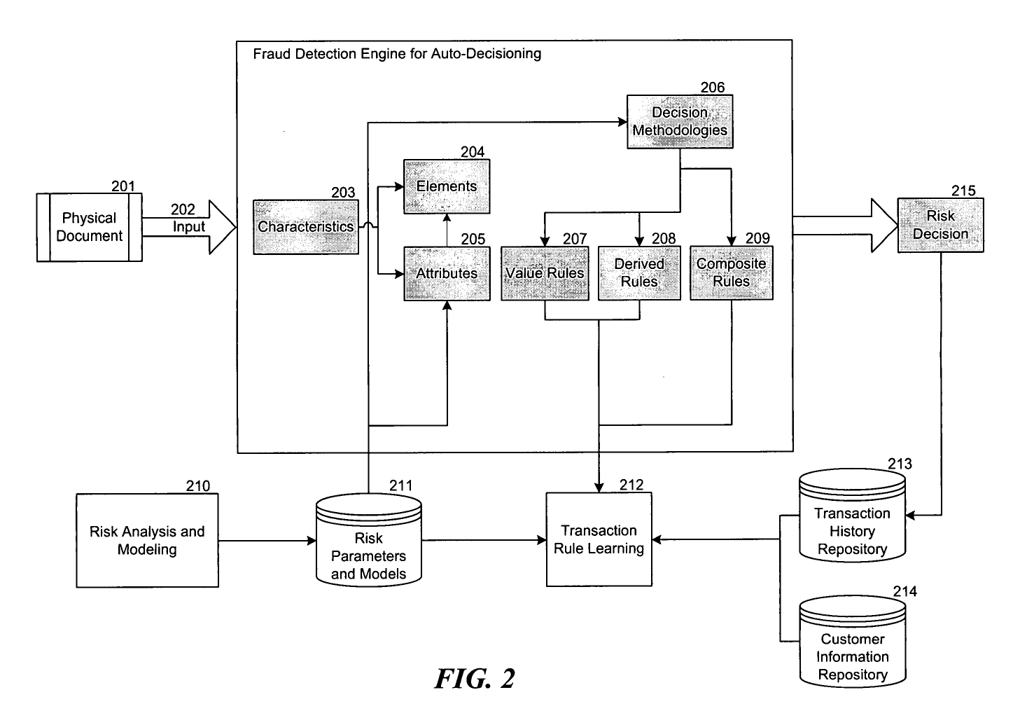

In the drawings, the same reference numbers identify identical or substantially similar elements or acts. To facilitate the discussion of any particular element or act, the most significant digit or digits in a reference number refer to the figure number in which that element is first introduced (e.g., element 204 is first introduced and discussed with respect to FIG. 2).

### DETAILED DESCRIPTION

The invention will now be described with respect to various embodiments. The following description provides specific details for a thorough understanding of, and enabling description for, these embodiments of the invention. However, one skilled in the art will understand that the invention may be practiced without these details. In other instances, well-known structures and functions have not been shown or described in detail to avoid unnecessarily obscuring the description of the embodiments of the invention.

It is intended that the terminology used in the description presented be interpreted in its broadest reasonable manner, even though it is being used in conjunction with a detailed description of certain specific embodiments of the invention. Certain terms may even be emphasized below; however, any terminology intended to be interpreted in any restricted manner will be overtly and specifically defined as such in this Detailed Description section.

I. Overview

Described in detail below is an end-to-end automated and semi-automated note, draft, or check cashing facility that includes an electronic customer enrollment component, a check enrollment component, and an adaptive risk-based check analysis/processing component. The end-to-end check cashing facility processes and analyzes paper checks of all types and varieties, as well as other negotiable instruments presented by customers to detect possible fraud. The end-to-end check cashing facility includes functionality that allows for adjustable and/or customizable risk management. Aspects of the facility apply to all negotiable instruments and commercial paper (e.g., those instruments and paper under UCC Articles 3 and 4).

In some embodiments, a typical check cashing process may begin by enrolling a new customer who is attempting to cash a check by presenting it to a retail clerk or bank teller or at an ATM. After enrolling the new customer (or, alternatively, validating a returning customer), the facility's electronic check enrollment component may enroll the check so that the facility's analysis component can access it and perform processing on its attributes.

Once a check is presented and subsequently enrolled, the analysis component may consider numerous attributes or variables (e.g., 4-6 areas or blocks of a paper check) and apply rules to each variable (or set of variables) to produce one or more scores or weighted values for the check. Based on this score, aspects of the analysis component may automatically formulate a decision regarding whether the check should be cashed. At the completion of the transaction, provided that the analysis does not result in a suspicion or discovery of fraud, a person or ATM may dispense cash to the customer. In some embodiments, the facility may include reporting components that report transaction records back to system administrators and the like.

In some embodiments, a fraud detection engine may perform analysis of documents, e.g., checks to be processed through the system. The fraud detection engine may run on a server computer and receive data through various interfaces and through preprocessing activities/analysis (which results in multiple variables that the fraud engine can then apply). An example of such an activity includes creating profiles or templates for checks for new customers and/or checks from new makers during enrollment. Using the received data, the fraud detection engine may compute a score or otherwise determine whether to approve a financial transaction. For example, the fraud detection engine may apply an algorithm that uses correlation and weighting on one or more of the multiple variables to determine authenticity of the document in regards to the purpose for which it was presented.

II. Representative Environment

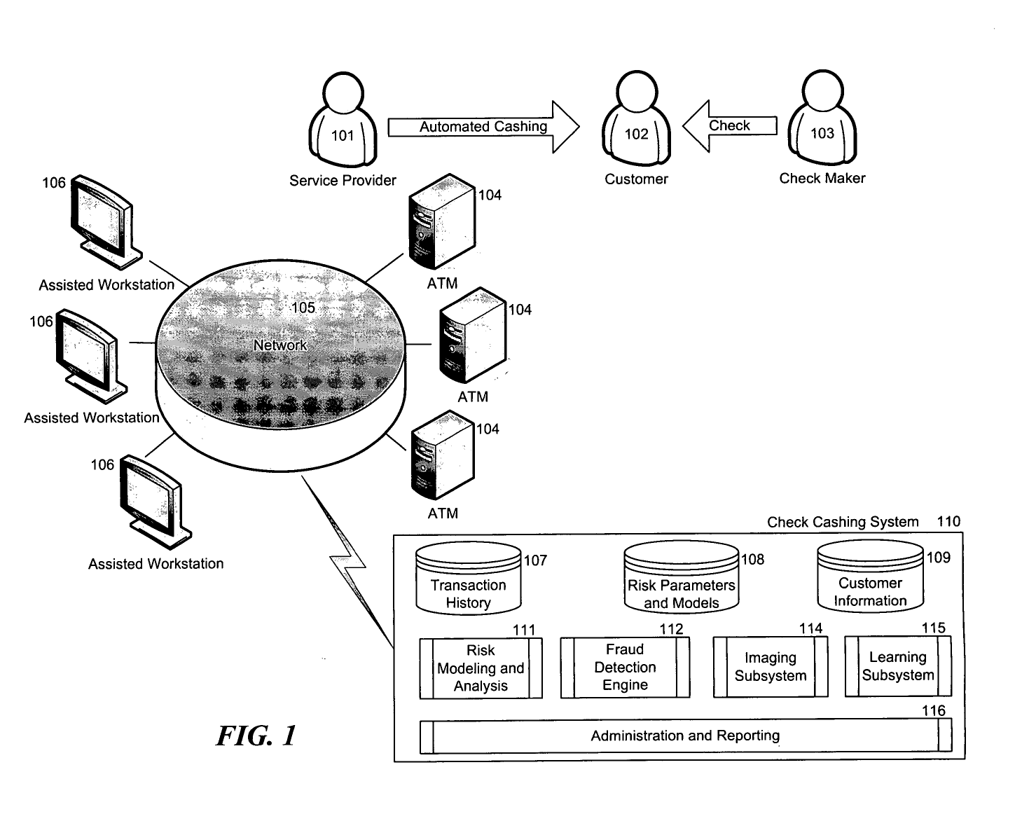

FIG. 1 and the following discussion provide a brief, general description of a suitable environment in which the facility can be implemented. Although not required, aspects of the facility are described in the general context of computer-executable instructions, such as routines executed by a general-purpose computer (e.g., a server computer, wireless device, or personal/laptop computer). Those skilled in the relevant art will appreciate that the invention can be practiced with other communications, data processing, or computer system configurations, including Internet appliances, hand-held devices (including personal digital assistants (PDAs)), wearable computers, all manner of cellular or mobile phones, embedded computers (including those coupled to vehicles), multi-processor systems, microprocessor-based or programmable consumer electronics, set-top boxes, network PCs, mini-computers, mainframe computers, and the like. Indeed, the terms “computer,” “host,” and “host computer” are generally used interchangeably and refer to any of the above devices and systems, as well as any data processor.

Aspects of the facility can be embodied in a special purpose computer or data processor that is specifically programmed, configured, or constructed to perform one or more of the computer-executable instructions explained in detail herein. Aspects of the facility can also be practiced in distributed computing environments where tasks or modules are performed by remote processing devices, which are linked through a communication network. In a distributed computing environment, program modules may be located in both local and remote memory storage devices.

Aspects of the facility may be stored or distributed on computer-readable media, including magnetically or optically readable computer disks, as microcode on semiconductor memory, nanotechnology memory, organic or optical memory, or other portable data storage media. Indeed, computer-implemented instructions, data structures, screen displays, and other data under aspects of the invention may be distributed over the Internet or over other networks (including wireless networks), on a propagated signal on a propagation medium (e.g., an electromagnetic wave(s), a sound wave, etc.) over a period of time, or may be provided on any analog or digital network (packet switched, circuit switched, or other scheme). Those skilled in the relevant art will recognize that portions of the invention reside on a server computer, while corresponding portions reside on a client computer, such as an ATM, a bank transaction computer, etc.

Referring to FIG. 1, the facility, which may be operated by a service provider 101, may cater to the needs of a note, draft, or check cashing customer 102 who receives a check or other document written or drawn by a check maker 103 (e.g., the employer of the check cashing customer, or some other party paying the customer 102 via check). Once in possession of the check, the customer 102 may visit an assisted workstation, such as a bank assisted workstation 106 operated by a teller, or an ATM 104, where the customer 102 may attempt to cash the check. The assisted workstation 106 or ATM 104 is in communication with a check cashing system 110 via a network 105 (e.g., a wide area network (WAN), a local area network (LAN), etc.). Accordingly, the assisted workstation 106, the ATM 104, and the check cashing system 110 may include web interfaces, which may include a browser program module that permits the facility and associated components to access and exchange data via the network 105.

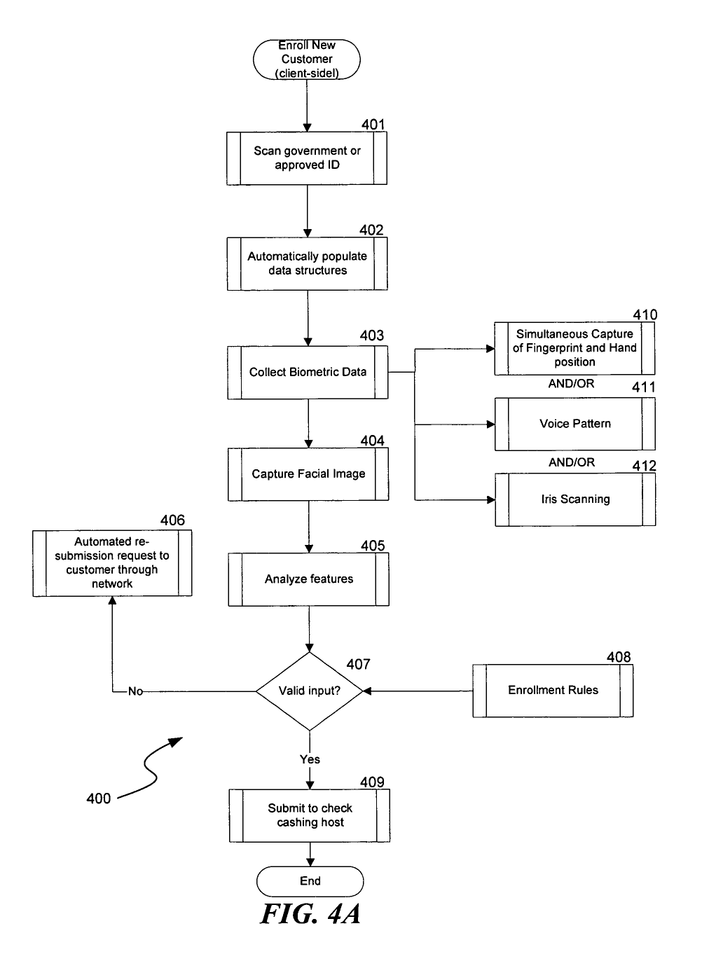

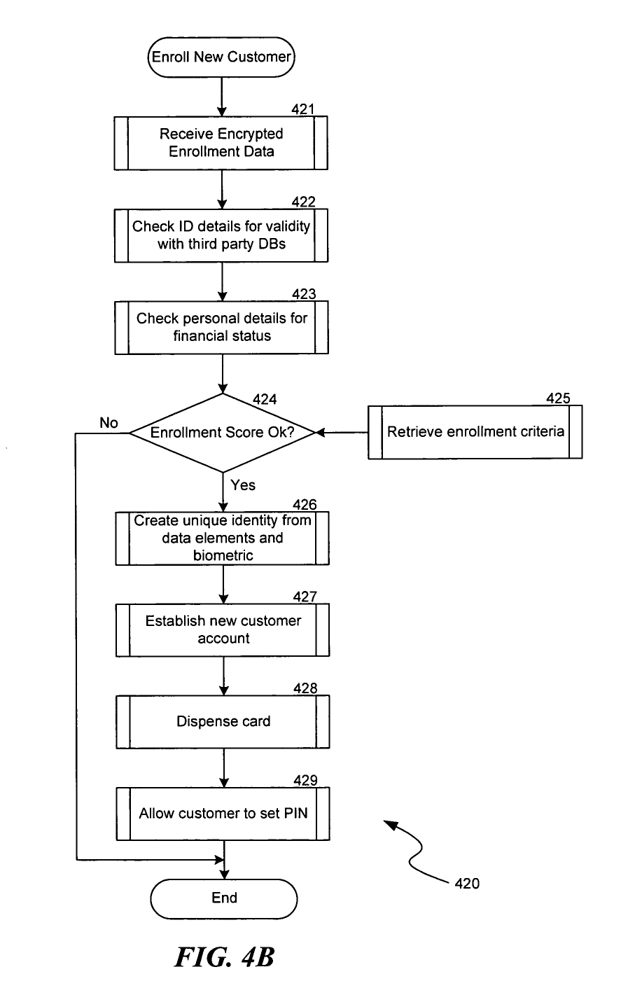

In some embodiments, the ATM 104 provides check cashing capabilities only for those customers who have previously enrolled with the check cashing system 110 via a human assistant. In such a case, if a new customer attempts to cash a check at the ATM 104, he or she may be redirected to the assisted workstation 106, which is configured for the enrollment of new customers. However, in alternate embodiments, the ATM 104 is also configured for enrolling new customers. Routines associated with customer enrollment are described below with respect to FIGS. 4A and 4B.

The assisted workstation 106 and the ATM 104 include well-known computer components (not shown) such as one or more processors coupled to one or more user input devices and data storage devices. The assisted workstation 106 and ATM 104 may also be coupled to at least one output device, such as a display device, and one or more additional output devices (e.g., printer, speakers, tactile or olfactory output devices, etc.). The input devices of the assisted workstation 106 and ATM 104 may include a keyboard/keypad and/or a pointing device, such as a mouse. Other input devices are also possible, such as a bar code reader/scanner, magnetic card-swipe reader, check reader, fingerprint reader, microphone, joystick, pen, game pad, scanner, digital camera, video camera, and the like. Many of these input devices may facilitate the enrollment of new customers, the verification of existing customers, and the enrollment of checks.

In some embodiments, the check cashing system 110 includes a transaction history repository 107, as well as a risk parameters and models repository 108 and a customer information repository 109. The transaction history repository 107, risk parameters and models repository 108, customer information repository 109, and other data storage devices associated with the facility may include any type of computer-readable media that can store data accessible by the facility, such as magnetic hard and floppy disk drives, optical disk drives, magnetic cassettes, tape drives, flash memory cards, digital video disks (DVDs), Bernoulli cartridges, RAMs, ROMs, smart cards, etc. Indeed, any medium for storing or transmitting computer-readable instructions and data may be employed, including a connection port or node on the network 105 (which may be a local area network, wide area network, or the Internet).

The check cashing system 110 may also include a risk modeling and analysis component 111, a fraud detection engine 112, an imaging subsystem 114, and a learning subsystem 115. The check cashing system 110 may further include an administration and reporting module 116 that provides services to administrative users of the check cashing system 110 (e.g., bankers, check cashing system administrators, etc.). For example, the administration and reporting module 116 may include management and configuration controls comprising a suite of tools. These tools may allow for the configuration and administration of the assisted workstations 106 and ATMs 104 and may allow for the modification of users and rules associated with the check cashing system 110. The administration and reporting module 116 may also provide a user interface to the transaction history repository 107, which permits reporting based on a multilevel access control structure. Reporting can be done on transactions, customers, device status, etc., through a provided interface. In addition, the administration and reporting module 116 may be used to maintain profiles for the fraud detection engine 112.

In some embodiments, the fraud detection engine 112 receives multivariable image data and attributes data. The received data may include data captured from the presented document(s) (e.g., using the imaging subsystem 114) as well as from user input collected at the time the document(s) are presented to the check cashing system 110. After receiving the data, the fraud detection engine 112 computes a score or otherwise determines whether to approve a given transaction. For example, the fraud detection engine 112 may apply a series of algorithms, correlations between attributes, etc., to the received data. This may result in one or more variables, to which the fraud detection engine 112 may apply one or more weighting factors. Examples of some of the variables are described in more detail with respect to FIG. 2, which is a more detailed view of a fraud detection engine and associated components.

Referring to FIG. 2, a fraud detection engine, such as the fraud detection engine 112 of FIG. 1, is shown in detail. In some embodiments, the fraud detection engine 112 may utilize an asynchronous transaction execution environment where multiple analysis algorithms run simultaneously. In this way, the fraud detection engine 112 can run as efficiently as possible and provide automated decisions (e.g., decisions based on a desired risk metric as specified by an administrative user), within a minimal allotted timeframe. In some embodiments, the fraud detection engine 112 is configured to take data from any input device and return an answer (e.g., “ok to cash check” or “do not cash check”) to any delivery device. Input 202, originating from an input source, such as from a scanning of a physical document 201, may include many characteristics from which both elements 204 and attributes 205 can be extracted. For example, the elements 204 may be associated with select features taken from a check (e.g., during a check enrollment process). Examples of the attributes 205 may include data parameters and other characteristics gathered from a customer enrollment process, a pending transaction, third-party databases, and the customer's and/or maker's history of activity with the fraud detection engine 112 (which may be stored in a transaction history repository 213). The analysis of the presenter (e.g., a human person) coupled with information from a computerized analysis of the document represent characteristics 203 of interest in the transaction. Mathematical analysis of the computer representation of the characteristics results in transactional elements 204 for use in the decisioning process itself.

The fraud detection engine 112 may be configured as a rules-based application in some embodiments. The fraud detection engine 112 may also use rules-based and other automated problem solving methods and algorithms in a sequence to perform the decision method. Accordingly, the building blocks of the fraud detection engine 112 may include various decision methodologies 206 used for analysis, such as value rules 207, derived rules 208, and composite rules 209. In some embodiments, the fraud detection engine 112 parameterizes the elements 204 and attributes 205 in light of these methodologies (and associated algorithms) prior to their application.

After analysis and parameterization of the elements 204 and attributes 205 from the physical characteristics 203, the fraud detection engine 112 may apply the various decision methodologies 206 and rules (207, 208, and 209) to come up with a score (or set of scores) for any particular transaction. In some embodiments, value rules 207 function by arriving at a definitive value either by a validation logic defined within the fraud detection engine 112 itself or by having a third-party processor validate it. In such a case, each value may have a predefined score associated with it. For example, the Social Security Number (SSN) can be either “Valid” or “Invalid.” If the SSN is Valid, the score for the SSN rule could be 1, and if it is Invalid, it could be −1. Derived rules subject some component of the transaction to a specified calculation. For example, an amount variance value may be calculated by deriving a z-score of the amounts on all the checks presented by that customer so far. Composite rules function by aggregating the scores of other simple rules by applying a specified aggregation method. For example, the score for a customer enrollment rule may be determined by averaging the scores of a collection of simple sub-rules.

For example, the fraud detection engine 112 may use the value rules 207 for identifying a specific value for a given characteristic (e.g., whether an ID is valid or invalid). Likewise, the fraud detection engine 112 may use the derived rules 208 to calculate specific components of a transaction (e.g., data variance). The fraud detection engine may use the composite rules 209 for aggregating individual rules to produce a single score for the check cashing transaction.

Examples of some of the variables associated with application of these various rules (207, 208, and 209) include variables associated with transactions (e.g., account status (based on information received from STAR, ABA, etc.), check velocity, check amount variance, check frequency variance, check date variance, check amount threshold, maker amount threshold, etc.); variables associated with check analysis (e.g., courtesy and legal amount, payee recognition, signature verification, maker/MICR validation, data header verification, check and vendor number, enhanced image analysis, etc.); variables associated with customer identification (e.g., biometric information such as the fingerprint, retinal scan, voice pattern, ID card type, SSN, date of birth, permanent address, death master list, third-party database variables (known offender, FBI, etc.), etc.); variables associated with the current transactional instance (time of day, geographic location, unique location of the input device, etc.); and variables associated with account history (e.g., composite score and data range, account data freshness, customer level, card activity, etc.).

The following tables provide examples of various rules that the fraud detection engine 112 may apply:

TABLE A
Customer Based Rules

| | Weighting | | | | |
|---|---|---|---|---|---|
| Component | Enrollment | Repeat | Result | Implication | Outcome |
| Biometrics (e.g., | — | — | Match | Positive | Go to next step |
| fingerprint lookup) | | | Found | | |
| | | | No Match | Negative | Decline |
| | | | Found | | |
| ID Lookup | — | — | ID | Positive | Go to next step |
| | | | Validated | | |
| | | | ID Not | Negative | Decline |
| | | | Validated | | |
| Customer Status | — | — | Enrolled | Positive | Go to next step |
| | | | Blocked | Negative | Decline |

TABLE B
Check and Maker Rules

| | Weighting | | | | |
|---|---|---|---|---|---|
| Component | Enrollment | Repeat | Result | Implication | Outcome |
| Third Party | | | Approved | Positive | Go to next |
| Guarantor | | | | | step |
| | | | Not Approved | Negative | Decline |
| Account Lookup | 10% | 10% | Account | Positive | Go to next |
| | | | Validated | | step |
| | | | Account Not | Negative | Decline |
| | | | Validated | | |
| Paper Verification | 25% | 20% | Good Paper | Positive | Go to next |
| (e.g., using | | | | | step |
| Parascript) | | | Bad Paper | Positive | Go to next |
| | | | | (Lower) | step |
| | | | Template | Negative | Decline |
| | | | Blocked | | |
| Maker Status | 10% | 10% | Enrolled | Positive | Part of scoring |
| | | | Customer | | |
| | | | with Enrolled | | |
| | | | Maker | | |
| | | | Enrolled | Positive | Part of scoring |
| | | | Customer, | (Lower) | |
| | | | Enrolled | | |
| | | | Maker | | |
| | | | Enrolled | Neutral | Part of scoring |
| | | | Customer, | | |
| | | | New Maker | | |
| | | | Blocked | Negative | Decline |

TABLE C
Velocity/Transaction Rules

| | Weighting | | | | |
|---|---|---|---|---|---|
| Component | Enrollment | Repeat | Result | Implication | Score |
| Check Velocity | — | 20% | Total number of | Positive | Part of |
| | | | checks in duration < max_limit | | scoring |
| | | | Total number of | Negative | Decline |
| | | | checks in duration > max_limit | | |
| Check Amount | — | — | −max_limit <= $ amt | Positive | Part of |
| Variance | | | z-score <= max_limit | | scoring |
| | | | $amt z-score < −max_limit | Positive | Part of |
| | | | | (Lower) | scoring |
| | | | $amt z-score > max_limit | Negative | Decline |
| Check | — | — | −max_limit <= num of | Positive | Part of |
| Presentment | | | days z-score <= max_limit | | scoring |
| frequency | | | Num of days z-score < −max- | Positive | Part of |
| variance* | | | limit | (lower) | scoring |
| | | | Num of days z-score > max_limit | Negative | Decline |
| Daily/Weekly | — | — | Total number of | Positive | Part of |
| Check Velocity | | | checks in 1 week/ | | scoring |
| | | | day < max_limit | | |
| | | | Total number of | Negative | Decline |
| | | | checks in 1 week/day > max_limit | | |
| Check Amount | 20% | 10% | Check_amount <= max_limit | Positive | ((max_limit − current_total) × 100)/ |
| Threshold | | | | | max_limit |
| (Max amount | | | Check_amount > max_limit | Negative | Decline |
| allowed per | | | | | |
| person in | | | | | |
| specified | | | | | |
| duration) | | | | | |
| Maker Amount | 20% | 10% | Check_amount <= max_limit | Positive | ((max_limit − current_total) × 100)/ |
| Threshold | | | | | max_limit |
| (Max amount | | | Check_amount > max_limit | Negative | Decline |
| allowed per | | | | | |
| maker in | | | | | |
| specified | | | | | |
| duration across | | | | | |
| various | | | | | |
| checks) | | | | | |

TABLE D
Composite Rules

| | | Weighting | | |
|---|---|---|---|---|
| Composite | Components | Enrollment | Repeat | Score |
| Check Behavior | C1. Check Amount Variance | — | 20% | C1 * C2 |
| | C2. Check Presentment Frequency | | | |
| Customer | C1. SSN | 15% | — | Average |
| Behavior | C2. Phone | | | (C1, C2, |
| | C3. ID Number | | | C3, C4) |
| | C4. Address | | | |
| Maker | C1. Maker - Number of Checks | — | — | Average |
| Confidence Index | C2. Maker - Number of Employees | | | (C1, C2, |
| (MCI) - (May not | C3. Maker - Average Amount on | | | C3, C4, C5, |
| be used directly | Checks | | | C6) |
| in scoring - but | C4. Maker - Flux in Amounts | | | |
| may affect | C5. Maker - Frequency of Check | | | |
| thresholds) | Issue | | | |
| | C6. Maker - Max Amount on | | | |
| | Checks | | | |

TABLE E
Value Rules

| Rule | Value | Score |
|---|---|---|
| SSN | Valid | 1 |
| | Invalid | −1 |
| ID-Number | Valid | 1 |
| | Invalid | −1 |
| Address | Valid | 1 |
| | Invalid | −1 |
| StarCheck | Account Not Found | 0 |
| | Invalid Account | −1 |
| | Valid Account | 1 |

TABLE F
Derived Rules

| Rule | Duration | Max Limit | Unit | Target | Type |
|---|---|---|---|---|---|
| Check Velocity | 15 days | 5 | days | Check | Count |
| Check | All | 1 | days | Check | z-score |
| Presentment | | | | | |
| Frequency | | | | | |
| Check Amount | All | 1 | amount | Check | z-score |
| Variance | | | | | |
| Check Amount | 15 days | 1000 | amount | Check | Sum |
| Threshold | | | | | |
| Maker Amount | 15 days | 10000 | amount | Maker | Sum |
| Threshold | | | | | |
| Parascript - | — | 100 | score | Check | Percentage |
| Template Score | | | | | |

TABLE G
Composite Rules

| Rule | Value | Weight | Aggregation Method |
|---|---|---|---|
| Check Behavior | Check Amount | 1 | Multiply |
| | Variance | | |
| | Check Presentment | 1 | Multiply |
| | Frequency | | |

While specific rules and variables are described above, one skilled in the art would appreciate that other rules and variables may be used when applying the decision methodologies 206 at the fraud detection engine 112.

In some embodiments, the fraud detection engine 112 may cross-correlate individual and composite elements and/or scores to produce additional unique points of analysis and/or fraud indicators. Ultimately, by applying the decision methodologies 206 and cross-corollaries to the elements 204 and attributes 205, the fraud detection engine 112 may provide a reference to a specified indicator or category that can be used to determine whether a check should be cashed.

In some embodiments, the fraud detection engine 112 may be associated with a risk analysis and modeling component 210 that, based on a set of risk parameters and models (e.g., stored in a risk parameters and models repository 211), is configured to formulate a series of automated scores on critical aspects of each transaction, ultimately resulting in an automated final decision output 215. An example of functionality provided by the risk analysis and modeling component 210 includes providing an inference into an intention or behavior. For example, if a customer's previous transactions were consistently associated with cashing checks around the $500 level, when a check at a higher level is presented by the customer, it is scored lower and could ultimately be declined due to the inconsistent check amount. Thus, inference rules may be used to speculate that a current transaction parameter (e.g., the check amount) was inconsistent with past customer behavior.

In some embodiments, the risk analysis and modeling component 210 is configured so that an administrator can custom tune it to a desired risk-target level. For example, institutions that charge a higher fee to cash checks may be amenable to a higher risk level than those who charge no fee (or only a nominal fee). Likewise, the functionality of the risk analysis and modeling component 210 may be augmented by intervention from either a call center or a human assistant, when needed.

In some embodiments, the fraud detection engine 112 is configured to automatically learn from each transaction. Accordingly, in such cases, the fraud detection engine includes a transaction rule learning component 212 that automatically updates the transaction history repository 213 to indicate the decision basis, including individual and composite data gathered from each transaction. Thus, the transaction history repository 213 may be a distributed and secure repository of information for any input data 202, as well as transaction history and information on risk management classification. The transaction rule learning facility 212 may also interact with a customer information repository 214.

By merging a decision basis with the actual transaction disposition, the transaction rule learning facility 212 may formulate the efficacy of the decision for a current transaction. Based, at least in part, on the information stored in the transaction history repository 107, the transaction rule learning facility 212 may be used to increase the confidence of the rules or algorithms used in the situation and to update the fraud decision methodologies 206 and associated rules (207, 208, and 209) to reflect new knowledge. Via an automated or partially automated risk modeling process, the fraud detection engine 112 may then be directed to apply new knowledge provided by the transaction rule learning facility 212 as a set of “learnings” to each subsequent transaction. The fraud detection engine 112 may, thus, validate new knowledge through positive incidents from subsequent transaction analysis, which results in increased confidence for each specific rule that it applies, meaning that the capabilities of the fraud detection engine 112 increase with each check cashing transaction.

III. System Flows

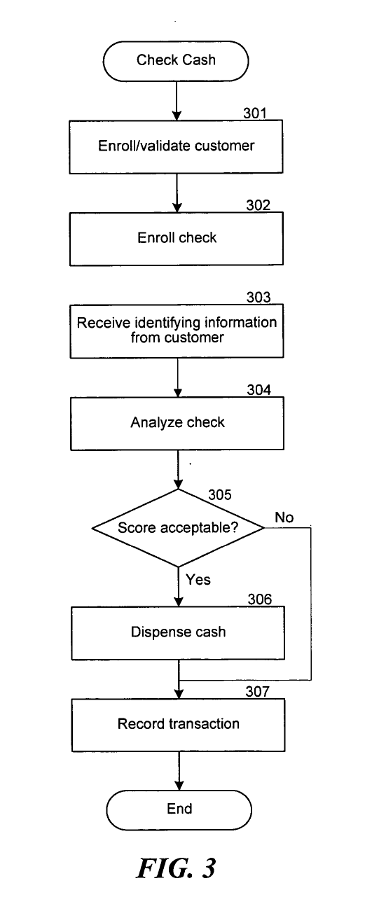

FIGS. 3 through 6 are representative flow diagrams that show processes that occur within the system of FIG. 1. These flow diagrams do not show all functions or exchanges of data but, instead, provide an understanding of commands and data exchanged under the system. Those skilled in the relevant art will recognize that some functions or exchanges of commands and data may be repeated, varied, omitted, or supplemented, and other aspects not shown may be readily implemented. For example, while not described in detail, a message containing data may be transmitted through a message queue, over HTTPS, etc.

FIG. 3 is a flow diagram showing an example of a routine or process 300 performed by the facility to cash a check. At block 301, the facility enrolls a new check cashing customer or validates a returning check cashing customer. For example, a new check cashing customer may present an ID and provide biometric and personal information to a bank teller to become enrolled, as described in more detail with respect to FIG. 4A. Likewise, a returning check cashing customer may provide a check cashing access card and personal identification number at an ATM for verification by the facility. A returning check cashing customer may also provide fingerprints or any other type or combination of personal information.

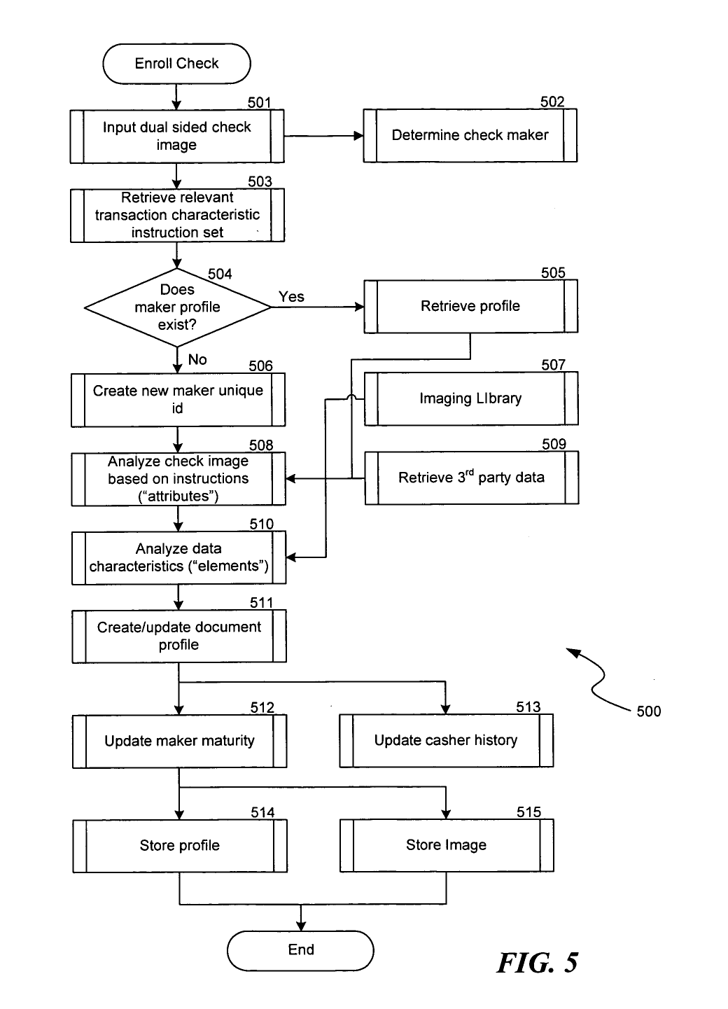

At block 302, the facility enrolls a check provided by the check cashing customer. This may also involve generating a profile associated with the check maker. For example, the check may be inserted into a check reading/scanning device so that the reading/scanning device can capture an image of the front and back side of the check. As part of the check enrollment process, the image of the check may be preprocessed, as discussed in more detail with respect to FIG. 5. At block 303, the transaction advances by receiving a card/PIN combination, a biometric/PIN combination, or other identifying information from the customer.

At block 304, the facility analyzes the check (e.g., via a fraud detection engine as described in FIGS. 1 and 2) to produce a score associated with the check. This may include analyzing image features and data elements associated with the check. At decision block 305, the facility determines whether the score produced from the check analysis is acceptable (e.g., via the transaction rule learning facility 212 of FIG. 2). If the score is not acceptable and the decision is to not cash the check, the routine 300 declines the transaction and continues at block 307 (record decision and context of transaction). However, if at decision block 305, the score is acceptable and the decision is to accept the check, the routine 300 continues at block 306, where funds are dispensed to the user. At block 307, the routine 300 records the decision and context of the transaction. For example, the routine 300 may record the transaction in the transaction history repository 213 of FIG. 2.

In addition to scoring the transaction as described above, other information (e.g., bad check information received at a back end) may also be used to make an accept/reject decision. The following table illustrates examples of various decisions that the facility can make based on bad check information:

TABLE H

| Bad Check Reason | Data Inputs Affected | Decision on Check |
|---|---|---|
| Account Closed | Maker, Check Templates | Block (Reject message) |
| Non Sufficient | Maker | Suspend (can be re- |
| Funds | | opened if cleared on |
| | | second attempt) |
| Forgery | Customer, Check | Block (Reject message) |
| | Templates | |
| Stop Payment | Customer | Block (Reject message) |
| Account Not Known | Maker, Check Templates | Block (Reject message) |
| to Bank | | |
| Invalid Account | Maker, Check Templates | Block (Reject message) |
| Number | | |
| Other | Maker, Customer, Check | Block (Reject message) |
| | Templates | |

FIG. 4A is a flow diagram showing an example of a routine 400 for enrolling a new customer (e.g., at an assisted workstation, such as the assisted workstation 106 of FIG. 1 or at a suitably configured ATM). At blocks 401-405, the routine 400 collects data associated with the customer. This may include scanning a government or approved ID (block 401) (e.g., a government-issued driver's license, a Mexican matricula card, a green card, or other appropriate ID) and automatically populating one or more data structures with this information (block 402). At block 403, the routine 400 may collect biometric data from the user, including a simultaneous capture of fingerprint and hand position data (block 410), voice pattern capture (block 411), and/or iris scanning (block 412). At block 404, the routine 400 may capture facial image information. The device or devices used to collect the data associated with blocks 401-405 (and blocks 410-412) may include a PC-based or other terminal, a fingerprint scanner, a digital camera, a magnetic stripe encoder and image or code ID scanner, a check imaging device with an MICR reader, a pin pad, a printer for receipts, etc.

At block 405, the routine 400 analyzes features associated with the information collected at blocks 401-405. At decision block 407, if the features result in a finding of valid input based on the application of enrollment rules 408, the routine 400 continues at block 409 where it submits the information to an appropriate cashing host. Otherwise, if at decision block 405, the input is not valid, the routine 400 proceeds to block 406, where the routine 400 requests that the customer resubmit information.

FIG. 4B is a flow diagram showing an example of a routine 420 for receiving customer enrollment data at a check cashing system, such as the check cashing system 110 of FIG. 1. At block 421, the routine 420 receives sent (e.g., encrypted) enrollment data and may store such data at a customer information repository, such as the customer information repository 109 of FIG. 1. At block 422, the routine 420 checks the customer's inputted ID information for validity. For example, this may involve checking ID information against a third-party database. At block 423, the routine 420 checks the customer's inputted personal information for validity/financial status, which may also involve the use of third-party database information. The information collected in blocks 421-423 may be used, along with enrollment criteria (block 425) to formulate an enrollment score. Accordingly, at decision block 424, if the enrollment score is not acceptable, the routine 420 ends. If, however, at decision block 424, the enrollment score is acceptable, the routine 420 continues at blocks 426 and 427 to create a new customer identity and establish a new customer account based on the received information.

Once a customer account is established, the routine 420 may collect information to allow the customer to use the check cashing facility in the future without having to repeat the enrollment process. More specifically, at block 428, the routine 420 issues an access card for the user. For example, the customer may receive a card similar to an ATM cash card for future user verification purposes/access to the facility. Once the customer receives his or her card and PIN, it becomes very easy for the user to execute future check cashing transactions. In one scenario, the customer may simply visit an ATM station hosted by the facility, such as the ATM station 104 of FIG. 1, insert the card, enter the PIN (set by the customer at block 429), and, provided that fraud is not suspected, cash a check without having to go to a live teller.

FIG. 5 is a flow diagram showing an example of a routine 500 for enrolling a check. The check enrollment routine 500 may be based on a detailed image of a preprinted or handwritten check, which is scanned in or otherwise inputted at an assisted workstation or ATM, such as the assisted workstation 106 or ATM 104 of FIG. 1. In general, the enrollment routine 500 entails identifying the location and content of numerous specific fields of information represented by characteristics printed on and embedded within the check. This information may include maker logo, date, payee, payer, check number, legal amount, courtesy amount, memo, font, spacing, signature, image profiles, maker profiles, check casher profiles, handwriting, document background, paper stock, magnetic ink character recognition (MICR), and other extracted features and elements. In some embodiments, check enrollment enables the facility to apply adaptable, optimal, and potentially unlimited parameters on either individual features or characteristics of a document.

Beginning at block 501, the routine 500 receives one or more captured images, which each represent a detailed image of a check or portion of a check. In some embodiments, capturing the image may include scanning both a front side and back side of a check at an appropriate resolution level. For example, in some embodiments, the facility specifies that the image should meet a minimum quality standard to be accepted.

At block 502, the routine 500 determines a check maker associated with the check. At block 503, the routine 500 retrieves a relevant transaction characteristics instruction set for the transaction. For example, the transaction characteristics instruction set may contain information relating to how features/elements of the check image should be analyzed (e.g., at block 508). The transaction characteristics instruction set may also contain information allowing the routine 500 to determine whether a maker profile exists for the particular check/check maker (decision block 504). If at decision block 504, a maker profile exists, the routine 500 proceeds at block 505 to retrieve the profile information prior to analysis. If, however, at decision block 504, a profile for the check/check maker does not exist, the routine 500 continues at block 506, to create a new maker ID. In other words, the routine 500 checks to see whether the maker of the check is known to the facility. If the maker is not known to the facility, the routine 500 creates a new profile for that maker.

At block 508, the routine 500 analyzes the check image (e.g., based on instructions from the transaction characteristics instruction set) to identify attributes associated with the check. Part of the analysis may depend on information from third-party sources (block 509). For example, the routine 500 may check attributes such as signature, endorsement, courtesy amount recognition (CAR), legal amount recognition (LAR), etc. to determine that such attributes are, in fact, present on the document. Later on in the routine 500, such attributes may be compared against attributes of subsequent documents. At block 510, the routine 500 analyzes data characteristics of the check to identify elements associated with the check. For example, the transaction characteristics data may include transaction amount or date, customer information, and check maker information. Some of the transaction characteristics data may be extracted from the check imaging library (block 507), but it may also be entered by the user at the ATM (or by a person).

At block 511, the routine 500 creates or updates a document profile for the check. The routine 500 updates maker maturity information at block 512 and/or updates casher history at block 513. At block 514, the routine stores the document profile information. At block 515, the routine stores the profile image information. The routine then ends. For example, the routine 500 may create an image template of the entire document, which may then be used in an image-wise comparison to analyze subsequent images presented by the same customer or generated by the same maker. The representative profile and image template are two separate constructs within the system. They may be used individually or in combination for subsequent processing and decisioning.

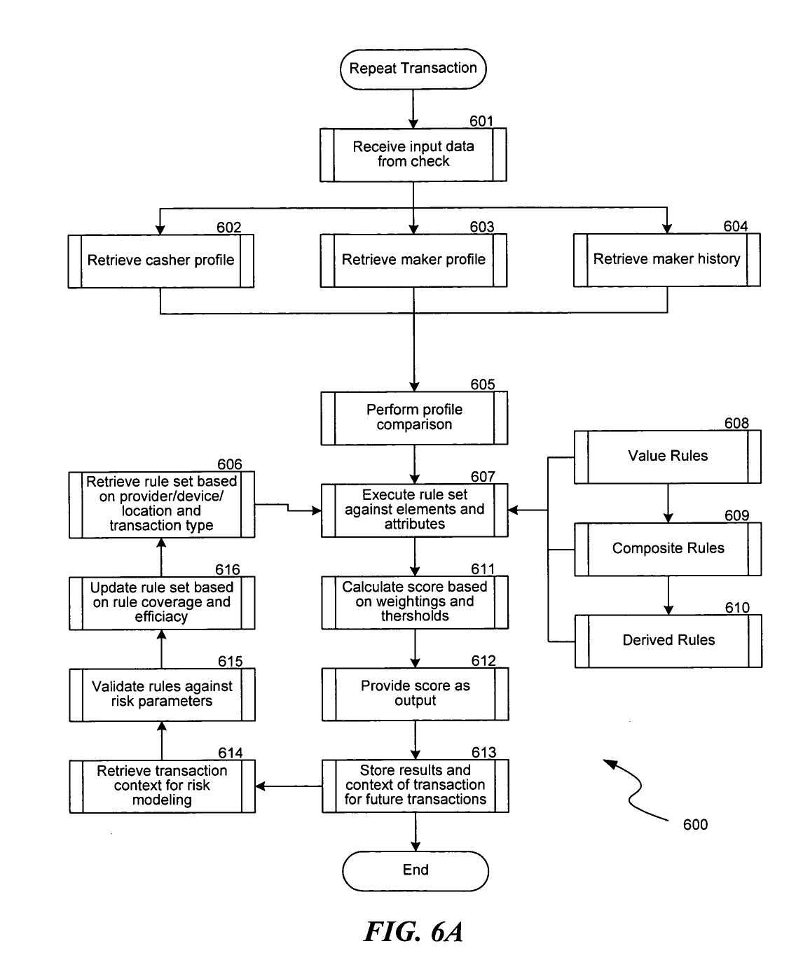

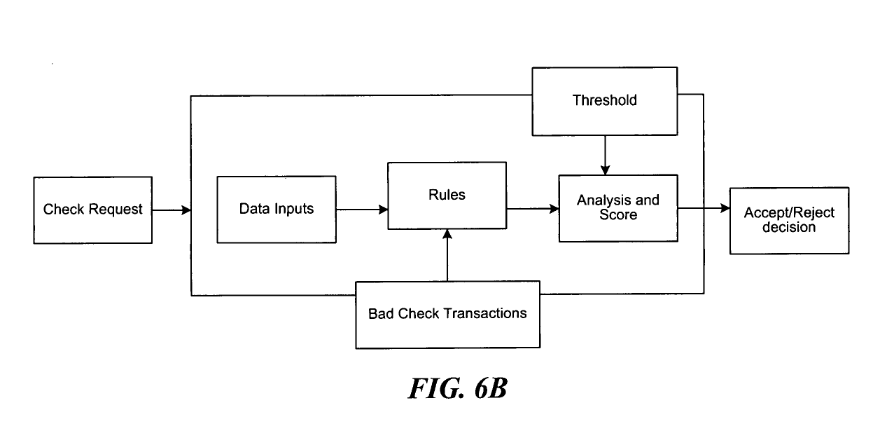

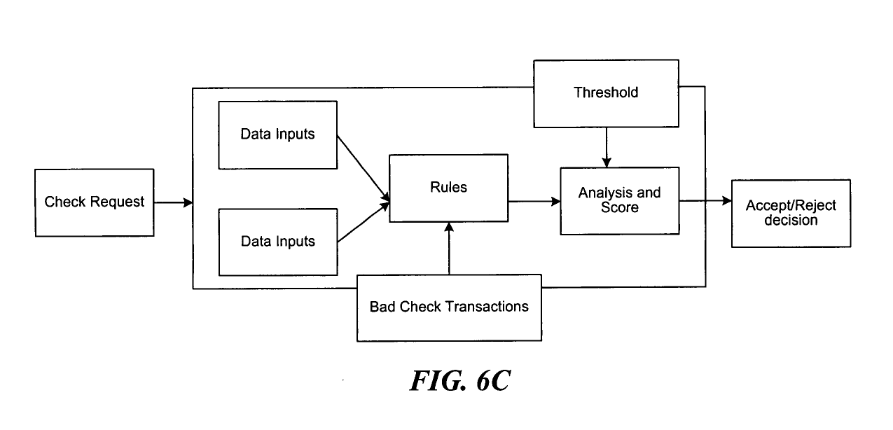

FIG. 6A is a flow diagram showing an example of a routine 600 performed by the fraud detection engine 112 to analyze a check or the like to determine whether it should be cashed. At block 601, the routine 600 receives input data, which may include preprocessed image data, profile-based data elements or other third-party information obtained during enrollment (see, e.g., FIG. 5) or subsequent transaction presentment. The input data may contain such information as the preprocessed image data received as a result of the check enrollment process 500 of FIG. 5. Further examples of the input for the fraud detection engine 112 are shown in the table that follows:

TABLE I

| Check | Customer | Maker | Past Transaction |
|---|---|---|---|
| Amount | Biometric image | Maker's Account | Date of check |
| | of fingerprint | Number | |
| Date | SSN | Routing Number | Amount of previous |
| | | | checks |
| MICR | Address | Enrollment status | Date of transaction |
| Signature | ID Number | Check template | Number of checks |
| Endorsement | Issuing State | | |
| | Type of ID | | |
| | Expiry Date | | |

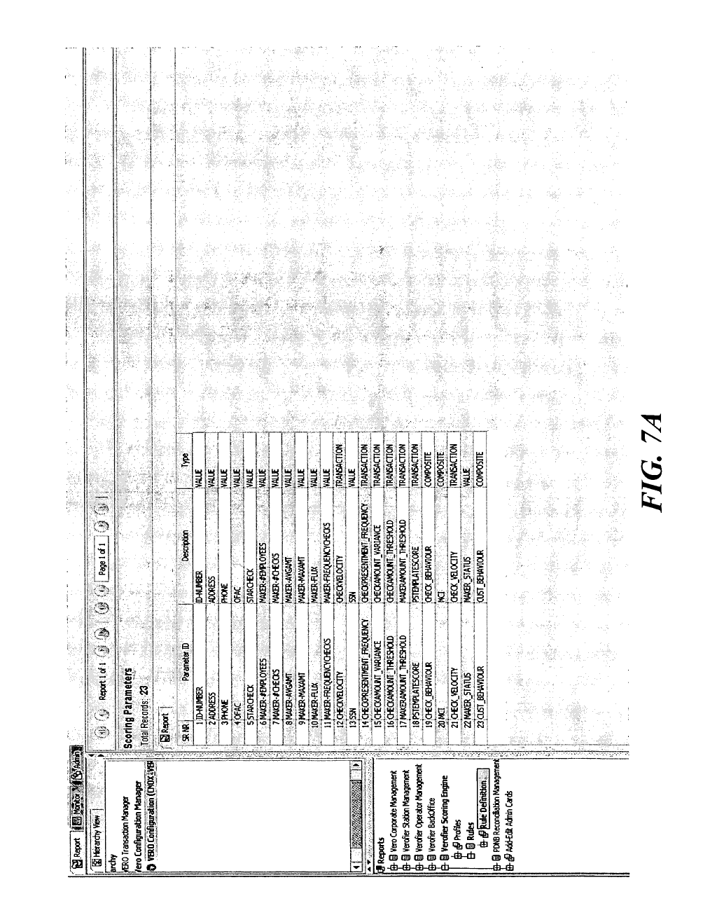

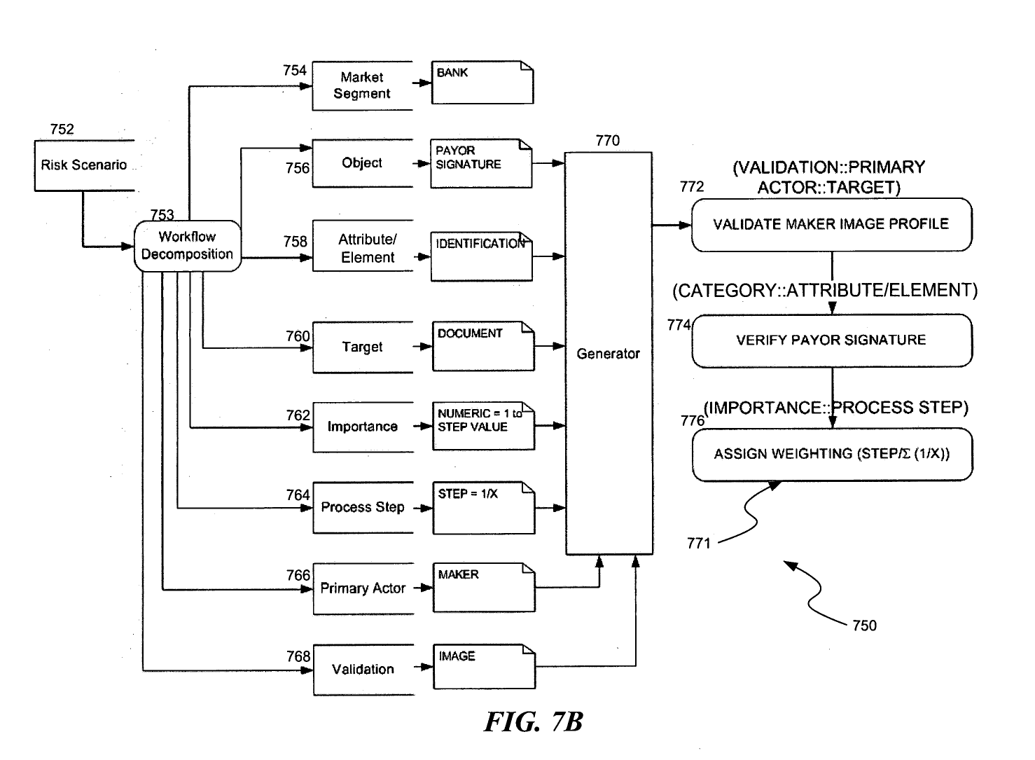

At block 602, the routine 600 retrieves a check casher profile for the customer (if one exists). At block 603 the routine 600 retrieves check maker profile information (if it exists). At block 604, the routine retrieves maker history information (if it exists). At block 605, the routine 600 performs a profile comparison. At block 607, the routine 600 detects, selects and executes the appropriate rules against the received input data for the presentment instance. For example, the routine 600 may apply value rules (block 608), composite rules (block 609), and/or derived rules (block 610). The routine may also apply learned rule factors based on previous transactions (block 606). In another example, the routine 600 applies composite rules and cross correlations to the received data and derived information. Application of the rules may include applying rule filters such as a high dollar filter (e.g., flags/screens out checks over a certain dollar amount), a non-MICR filter (e.g., flags/screens out checks with an improper or missing MICR), a data variance filter (e.g., flags/screens out checks that have unacceptable data variances), a new account filter (e.g., flags/screens out checks issued from a brand-new account), a watch account filter (e.g., flags/screens out checks issued from an account that has a “watch” placed on it), an amount variance filter (e.g., flags/screens out checks that have an amount that varies from similar checks in the past), a velocity filter (e.g., flags/screens out checks that are coming from a check casher who exceeds a certain number of transactions within a given amount of time), etc. Additional examples of rules are illustrated with respect to FIGS. 7A-13.

In some embodiments, analysis of the check may also include analyzing randomly selected or previously defined pixels in the image representation of the check presented for deformation from copying or alteration. It may also include analyzing paper stock for alteration, such as void reveals. Additional rules from third-party sources that implement new indicators or fraud signatures may also be added to the engine in order to adapt to new methods invented for fraudulent activity.

At block 611, the routine 600 calculates a score associated with the enrolled check. In some embodiments, each rule has a score and the scoring mechanism may be different for each rule. For example, for some rules, the score is 0 or 1 depending on whether the data input is binary. This works particularly well for data such as ID number, SSN, and gender. However, for other rules, such as check velocity, the score is derived by performing calculations (e.g., calculating the number of checks cashed in a specified duration). In the case of composite rules such as rules relating to customer enrollment, a score may be derived by validating each of the component rules.

In calculating the score at block 611, the routine 600 may score fields against the transaction history repository 107. In other words, the routine 600 may consider past transactions when scoring fields. At block 612, the routine 600 provides a calculated score as output. Examples of final scores (and possible corresponding decisions) are shown in the table below:

TABLE J

| Final Score Thresholds | Final Decision |
|---|---|
| Greater or equal to 0.501 | Accept Check-“Approved” |
| Less than or equal to 0.500 | Reject Check-“Declined” |

At block 613, the routine 600 may store the results and context of the transaction for use in determining risk for future transactions (blocks 614-616). More specifically, at block 614, the routine 600 may retrieve the transaction context for future risk modeling. At block 615, the routine 600 may validate rules against risk parameters. For example, different rules may be weighted based on a desired risk level for future transactions. At block 616, the routine 600 may update a rules set based on rule coverage and efficacy. For example, various rules may be applied differently (e.g., with different thresholds) in future transactions based on the results of applying these rules in past transactions. As shown at block 606, the updated rules information may then be used when the facility retrieves rule sets for subsequent transactions.

The learning activities performed in blocks 613-616 may include an analysis of actual rules triggered in previous transactions in light of the ultimate disposition of the current transaction, for example, whether or not the current check was returned as a “bad” check for a number of reasons including no maker account, insufficient funds, etc. The learning activities of blocks 613-616 facilitate weighting rules for application during subsequent transactions. In some embodiments, when a transaction result indicates fraudulent behavior that falls outside the applied rule set's detection capabilities, an automated component analysis and/or human intervention may allow the rule set to be updated (including adding new rules) in a way that allows the rule set to work more effectively against detecting such fraud in the future. In some embodiments, when a human or automated analysis suggests that a rule set be updated to include new rules, the facility may generate a rule activation message, which it sends to an administrator for analysis/approval of the new rules.

As shown in FIGS. 6B and 6C, in some embodiments, the fraud detection engine 112 works iteratively. An assumption in a first cycle (FIG. 6B) is that the customer is new, without a past check cashing history at the bank. In the second cycle (FIG. 6C), there are additional data inputs such as history of customer and actual bad checks if available, and, if appropriate, a different threshold is applied.

FIGS. 7A-13 are display diagrams showing an example of screen shots seen by an administrative user who is responsible for establishing a risk management scheme for document processing. FIG. 7A is a screen shot showing an example of a set of rules that the administrator may select from in establishing a risk management scheme. For example, the administrator may choose subsets of these rules for incorporation into a risk management scheme. In this way, administrative users can adjust risk levels so that more rules are applied and more factors are analyzed in cases where a low level of risk is desired and fewer factors are analyzed where a higher level of risk is acceptable. For example, a casino that provides check cashing service may be amenable to a higher level of risk (because it wants its customers to spend more money) when compared with a supermarket that provides check cashing as a courtesy and thus prefers establishing a lower risk level. Most of the rules that the administrator may select from correspond to information that is gathered and processed during a document transaction. In some embodiments, each rule has a weight associated with it. The weighted scores of all the rules put together allow the facility to derive a final score that is used to make the accept/reject decision on the check. Some of the information used in applying the rules is available from the document itself, while other aspects of the information are available from a check casher, third-party database, etc.

Some of the rules may be associated with customer behavior. For example, one or more rules may relate to ID fraud. For example, such a rule may issue a prompt for a check of ID validity (e.g., using ID number information), check the ID number against a third-party ID validation system, and alert a teller via the assisted work station that an ID is not valid. Likewise, one or more rules may relate to customer limits. For example, the fraud detection engine 112 may have the capability to assign a maximum dollar limit to the customer (which may pertain to a single check or to a specified time period).

Some of the rules may be associated with verifying the check itself. For example, check verification rules may use third-party tools (e.g., Parascript) to verify one or more templates against a presented check. If the check matches any one of the templates with a high score, there is a higher chance that the check will be cashed. However, if the check does not match the template, the final score is lower, and the probability that check will be cashed is decreased. Another rule type associated with verifying the check includes presentment frequency. For example, if a check is presented more frequently than defined for a predetermined duration, the final score decreases, reducing the probability that check will be cashed. Other check verification rules may include a rule that caps a check maker dollar amount over a time period, a rule that prevents older checks from being cashed, etc. In addition, bad check warnings may be collected from third-party sources (e.g., STAR Check) and may alert the facility of factors such as closed accounts, nonsufficient funds, forgery, stop payments, unknown accounts, invalid account numbers, etc.

FIG. 7B represents an example of a risk modeling workflow 750. The risk modeling workflow illustrates a process of decomposing a risk scenario 752 pertaining to a specific market segment 754 (e.g., bank, casino, retail, etc.) into a set of objects (756-768). Via an at least partially automated process (e.g., performed by a generator component 770), the set of objects (756-768) can then be transformed, with some consistency, into a risk rule set 771 for the real-time operation of the system when evaluating transactions for fraud.

Examples of objects that result from the decomposition 753 of the work flow may include a market segment object 754 (e.g., bank, casino, retail, etc.); an attribute/element object 756 (e.g., payor signature); a category object 758 (e.g., identification); a target object 760 (e.g., document, customer record, third-party data, etc.); an importance object 762 (e.g., may provide a numerical rating of how important the attribute/element is); a process step object 764 (e.g., may indicate how the object to be considered fits into a multistep process—such as 1 of 5 or 3 of 7); a primary actor object 766 (e.g., maker, customer, etc.); a validation object 768 (e.g., image); etc. For the given risk scenario 752, instances of these factors may be fed as input to the generator 770 (e.g., which may be part of an automated risk modeling and analysis component, such as the risk modeling and analysis component 111 of FIG. 1). The resulting risk rule set 771 may include various aspects such as a validation aspect 772 (e.g., validation of data associated with the maker image profile such as validation of a maker image profile), a verification aspect 774 (e.g., verify payor signature), and weight assignment aspect 776 (e.g., assign weighting to the rule set relative to other rules sets that may also be applied in a given transaction).

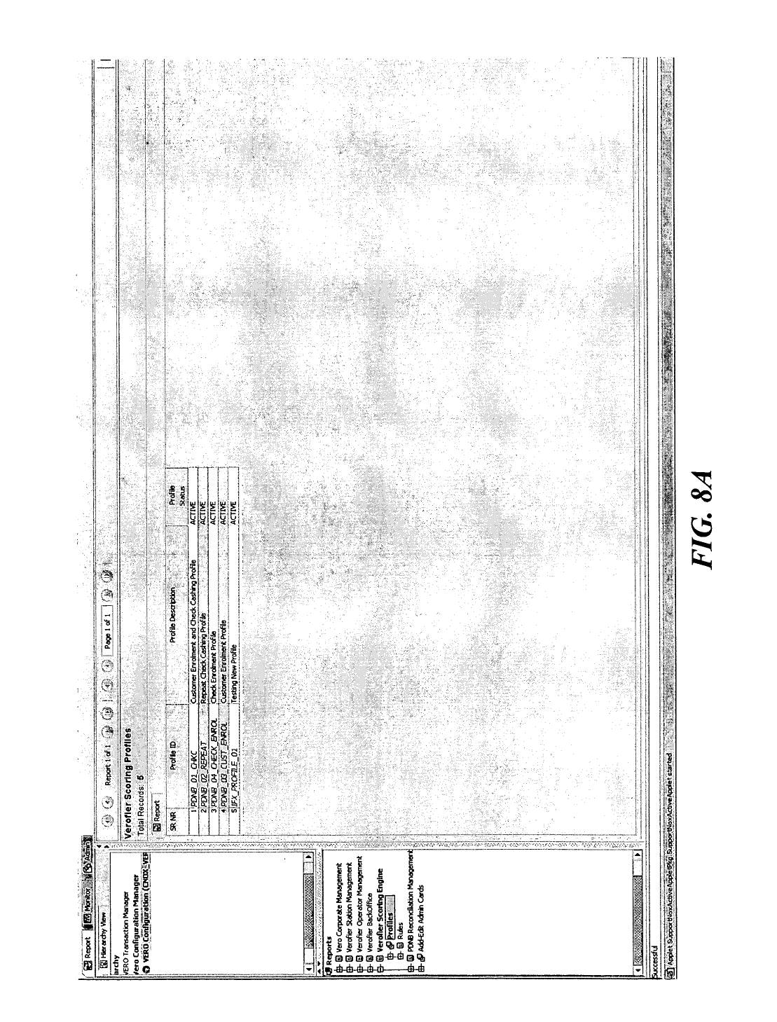

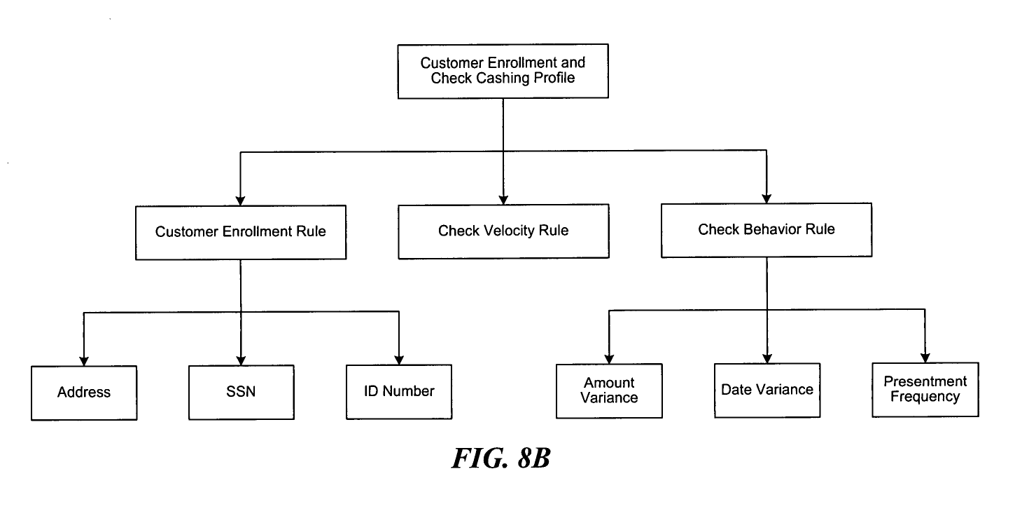

The screen shots that follow in FIGS. 8A-13 show an example of how the administrative user may be able to further define the specifics of how each one of the rules may be applied in a category of document transactions, including setting of thresholds.

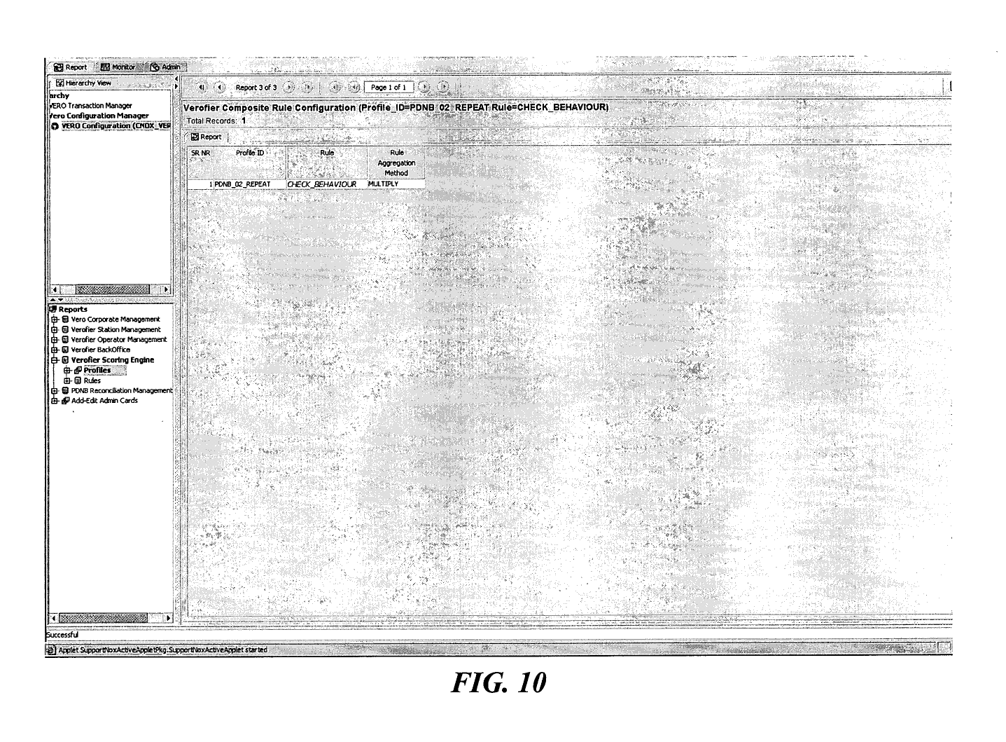

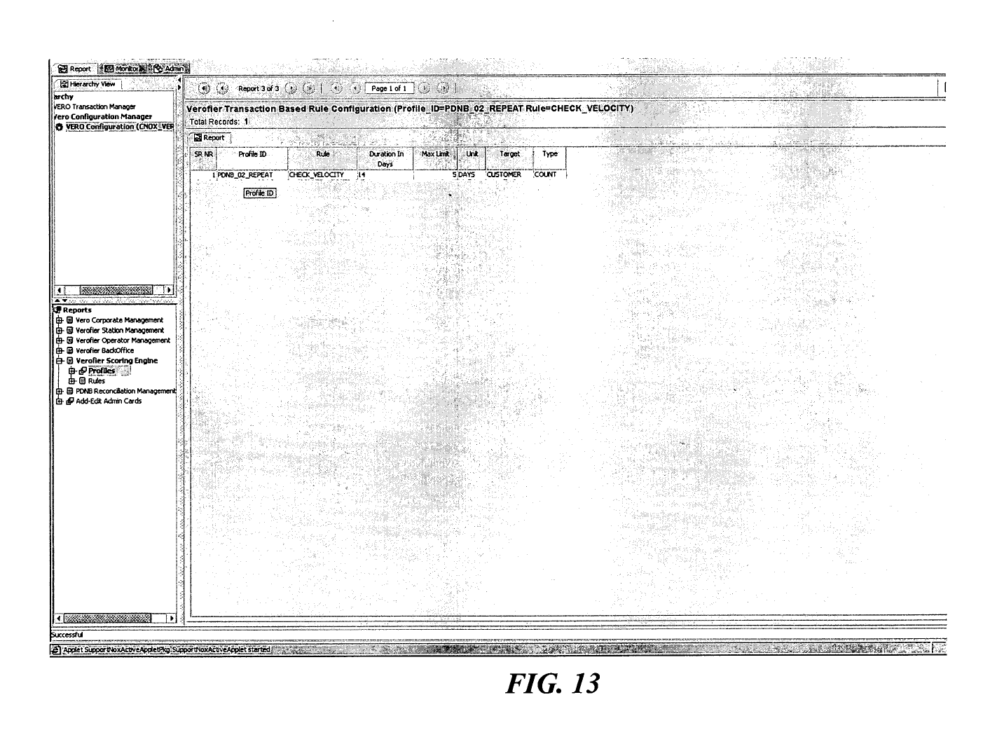

FIG. 8A is a screen shot showing a set of rule profiles, which may be used as a way to group rules into rule sets for different transaction types. In the illustrated embodiment, the rule profiles include profiles for customer enrollment and check cashing, repeat check cashing, check enrollment, and customer enrollment. In some embodiments, each of these profiles allow for grouping of rules by the administrative user. An example of an underlying framework for the customer enrollment and check cashing profile is shown in FIG. 8B. There may be various levels in a rules profile. For example, a rules profile may be made up of various simple and composite rules. A simple rule in the above example would be a check velocity rule, explained in more detail with respect to FIG. 13. A composite rule is one that is an aggregate of several other rules. A customer enrollment rule and a check behavior rule are examples of composite rules since they are made up of other rules. An example of a check behavior rule is explained in more detail with respect to FIGS. 10-12.

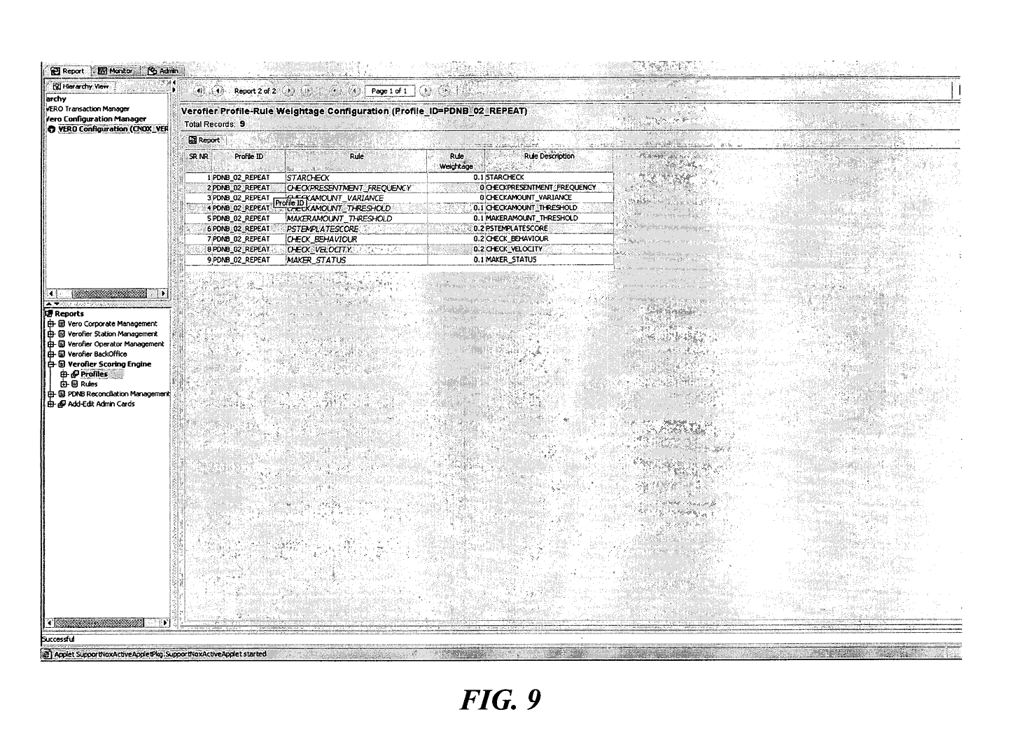

FIG. 9 is a screen shot showing a rule set associated with the repeat check cashing rule profile initially discussed with respect to FIG. 8A. As shown in FIG. 9, the repeat check cashing profile is associated with a subset of rules (taken from the set of rules of FIG. 7A). The screen of FIG. 9 allows the administrator to assign a weight to each rule (which determines how much relative importance that rule is given). The degree of weight assigned to each rule is flexible and can be adjusted depending on the levels of risk associated with a particular customer's profile. For a given transaction, an aggregation of the weighted scores results in a final score. The screen also provides additional details about the rule set, such as a rule description for each rule. Examples of rule weights are provided in the following table:

TABLE K
Rule Weights

Weight

| | | |
|---|---|---|
| Rule | Enrollment | Repeat |

| | | |
|---|---|---|
| Address | 5% | 0% |
| Check Amount Threshold | 5% | 20% |
| Check Behavior | 15% | 25% |
| Check Velocity | 5% | 10% |
| ID Number | 5% | 0% |
| Maker Amount Threshold | 5% | 20% |
| MCI | 15% | 0% |
| PS - Template Score | 15% | 15% |
| SSN | 5% | 0% |
| StarCheck | 10% | 10% |

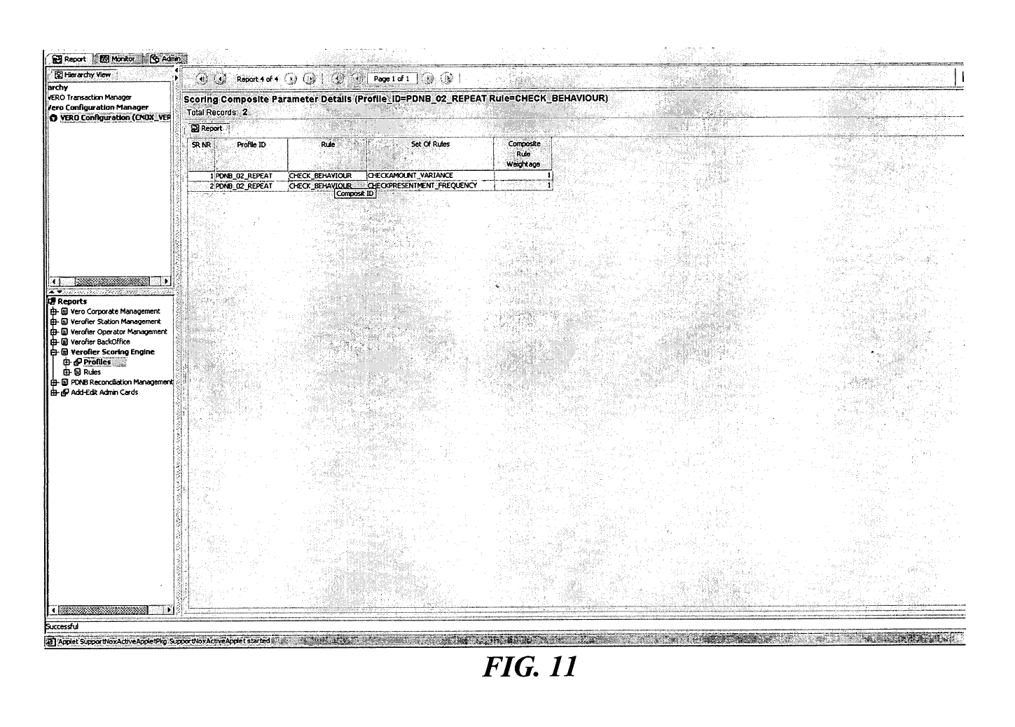

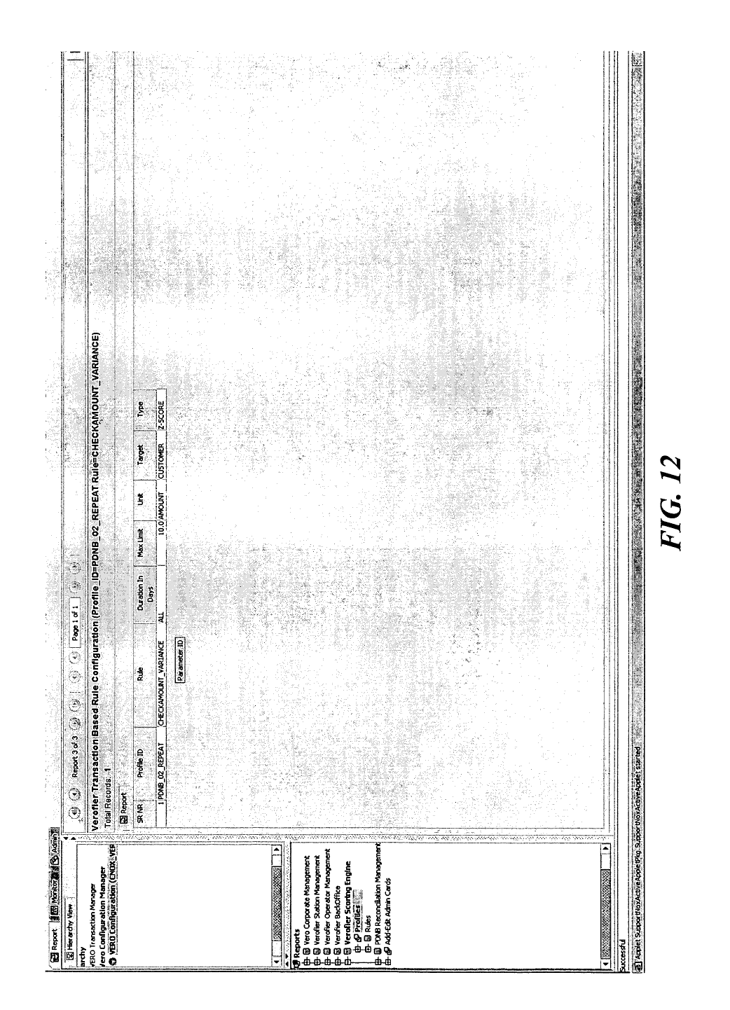

FIG. 10 is a screen shot showing a breakdown of aspects of one of the rules from the repeat check cashing profile (in particular, the CHECK_BEHAVIOR rule of FIG. 9). A MULTIPLY indication in a Rule Aggregation Method field indicates that the rule is a composite rule made up of multiple rules. The CHECK_BEHAVIOR rule's composite factors are illustrated in FIG. 11, and include CHECKAMOUNT_VARIANCE and CHECKPRESENTMENT_FREQUENCY. In some embodiments, each composite factor is given its own weighting. Details of the CHECKAMOUNT_VARIANCE composite factor are illustrated in FIG. 12. In particular, some details associated with CHECKAMOUNT_VARIANCE include duration in days, max limit, unit, target, and type.

FIG. 13 shows a further breakdown of aspects of the CHECK_VELOCITY rule, initially introduced with respect to FIG. 8B and FIG. 9 (which displays a rule set for a repeat check cashing profile). In the given example, CHECK_VELOCITY is not a composite rule. Accordingly, some of the details associated with this rule are shown in the screen of FIG. 13, and include values associated with a duration in days field, a max limit field, a unit field, a target field, and a type field. For example, according to this rule, the maximum number of times a person can attempt to come in and cash checks is five times within a fourteen-day period.

IV. Conclusion

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Additionally, the words “herein,” “above,” “below” and words of similar import, when used in this application, shall refer to this application as a whole and not to any particular portions of this application. When the claims use the word “or” in reference to a list of two or more items, that word covers all of the following interpretations of the word: any of the items in the list, all of the items in the list, and any combination of the items in the list.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times. Where the context permits, words in the above Detailed Description using the singular or plural number may also include the plural or singular number, respectively.

The teachings of the invention provided herein can be applied to other systems, not necessarily the system described herein. The elements and acts of the various embodiments described above can be combined to provide further embodiments.

All of the above patents and applications and other references, including any that may be listed in accompanying filing papers, are incorporated herein by reference. Aspects of the invention can be modified, if necessary, to employ the systems, functions, and concepts of the various references described above to provide yet further embodiments of the invention.

These and other changes can be made to the invention in light of the above Detailed Description. While the above description details certain embodiments of the invention and describes the best mode contemplated, no matter how detailed the above appears in text, the invention can be practiced in many ways. Details of the check cashing facility may vary considerably in their implementation details, while still be encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention under the claims.

While certain aspects of the invention are presented below in certain claim forms, the inventors contemplate the various aspects of the invention in any number of claim forms. For example, while only one aspect of the invention is recited as embodied in a computer-readable medium, other aspects may likewise be embodied in a computer-readable medium. Accordingly, the inventors reserve the right to add additional claims after filing the application to pursue such additional claim forms for other aspects of the invention.

[image]

[image]

### APPENDIX B: ILLUSTRATIVE EXAMPLES

### Example 1

### Accept Check (Enrolled Customer—1^{st} Transaction)

Data Inputs:

| Data Inputs | Value |
|---|---|
| SSN | 445-23-5189 |
| ID Number | D14367890 |
| Address | 1026 Gardenwood Drive, San Jose, CA - 95129 |
| Maker Routing Number | 123456789 |
| Maker Account Number | 12345678 |
| Amount | $150.00 |
| Date on Check | Oct. 7, 2004 |
| Date Presented | Oct. 8, 2004 |

Rules Scores:

| | | | Weighted |
|---|---|---|---|
| Rules | Value | Score | Score |
| SSN | 445-23-5189 | 1 | 0.05 |
| ID Number | D14367890 | 1 | 0.05 |
| Address | 1026 Gardenwood | 1 | 0.05 |
| | Drive, San Jose, | | |
| | CA-95129 | | |
| StarCheck | Valid Account | 1 | 0.10 |
| MCI | 0.67 | 0.67 | 0.10 |
| Check Velocity | 0 | 0.50 | 0.03 |
| Check Amount Variance | 0 | 1 | 0.00 |
| Check Presentment Frequency | 0 | 1 | 0.00 |
| Check Amount Threshold | | 0.85 | 0.04 |
| Maker Amount Threshold | | 0.99 | 0.05 |
| Check Behavior | | 1 | 0.15 |
| PS - Template Score | 75 | 0.75 | 0.11 |
| Final Score | | | 0.73 |
| Final Decision | | | Approved |

### Example 2

### Accept Check (Enrolled Customer—2^{nd} Transaction)

Inputs:

| Data Inputs | Value |
|---|---|
| SSN | 445-23-5189 |
| ID Number | D14367890 |
| Address | 1026 Gardenwood Drive, San Jose, CA - 95129 |
| Maker Routing Number | 123456789 |
| Maker Account Number | 12345678 |
| Amount | $130.00 |
| Date on Check | Oct. 12, 2004 |
| Date Presented | Oct. 13, 2004 |

Rules Scores:

| Rules | Value | Score | Weighted Score |
|---|---|---|---|
| StarCheck | Valid Account | 1 | 0.10 |
| Check Velocity | 2 | 0.75 | 0.08 |
| Check Amount Variance | 0 | 1 | 0.00 |
| Check Presentment Frequency | 0 | 1 | 0.00 |
| Check Amount Threshold | | 0.72 | 0.14 |
| Maker Amount Threshold | | 0.97 | 0.19 |
| Check Behavior | | 1 | 0.25 |
| PS - Template Score | 70 | 0.7 | 0.11 |
| Final Weighted Score | | | 0.87 |
| Final Decision | | | Approved |

### Example 3

### Reject Check (Enrolled Customer—3^{rd} Transaction)

Inputs:

| Data Inputs | Value |
|---|---|
| SSN | 445-23-5189 |
| ID Number | D14367890 |
| Address | 1026 Gardenwood Drive, San Jose, CA - 95129 |
| Maker Routing Number | 123456789 |
| Maker Account Number | 12345678 |
| Amount | $300.00 |
| Date on Check | Nov. 01, 2004 |
| Date Presented | Nov. 02, 2004 |

Rules Scores:

| | | | Weighted |
|---|---|---|---|
| Rules | Value | Score | Score |
| StarCheck | Valid Account | 1 | 0.10 |
| Check Velocity | 3 | 0.50 | 0.05 |
| Check Amount Variance | 1.99 | −10.00 | 0.00 |
| Check Presentment Frequency | 7.00 | −10.00 | 0.00 |
| Check Amount Threshold | | 0.575 | 0.12 |
| Maker Amount Threshold | | 0.96 | 0.19 |
| Check Behavior | | −100 | −25.00 |
| PS - Template Score | 75 | 0.75 | 0.11 |
| Final Weighted Score | | | −24.43 |
| Final Decision | | | Declined |

I/We claim:

1. A method for check cashing that is at least partially implemented at a computer, the method comprising:
enrolling a customer to associate the customer with a check cashing system, or, if the customer has been previously enrolled, verifying the identity of the previously enrolled customer;
enrolling a check that the customer wishes to cash, wherein the enrolling of the check includes:
capturing at least one image associated with the check,
isolating areas of the captured image for individual analysis,
if the check is from an unrecognized maker, creating a new processing profile based on the captured image, and
if the check is from a recognized maker, applying information from a previously generated processing template to the check;
analyzing the isolated areas based, at least in part, on the profile or through an applied template, wherein the analyzing includes:
applying rule-based algorithms to elements and characteristics of the isolated areas, and
generating at least one score for the enrolled check based on applying the rule-based algorithms, and
determining whether or not the enrolled check should be cashed based on the at least one score.

2. The method of claim 1 wherein the rule-based algorithms are generated by a method comprising:
decomposing a fraud risk from a singular objective to a set of optimized constraints; and
converting the set of optimized constraints to specific transaction-based rules through an automated process.

3. The method of claim 1 further comprising dispensing funds to the customer through a directed dispensing of cash, a partial allocation of funds to a virtual account, or a redirection of funds to another transaction type.

4. The method of claim 1 wherein enrolling the customer includes:
collecting data from the customer, including inputting biometric data collected from the customer in the form of fingerprint, retinal scan, voice pattern, or other personal identification information, taking a digital image of the customer's face, and scanning and authenticating a government issued or other identification card presented by the customer;
automatically populating account setup data structures using the collected data; and
using an algorithm to uniquely encrypt the collected data so that the encrypted collected data is usable to identify the customer during subsequent transactions.

5. The method of claim 1 wherein verifying the identity of the customer includes reading an access card provided by the customer and receiving a personal identification number input from the customer.

6. The method of claim 1 wherein verifying the identity of the customer includes authenticating an enrollment attribute set provided by the customer upon request.

7. The method of claim 1 wherein determining whether or not the enrolled check should be cashed is an automated decision, based at least in part on a risk tolerance level specified by an administrative user and subsequently decomposed into multiple attributes or parameters that are used as input when applying the rule-based algorithms.

8. A method for customizable risk management in a check cashing system, the method comprising:
decomposing a fraud risk scenario associated with check cashing, wherein decomposing the fraud risk is performed using a first at least partially automated process for generating a set of risk factor objects related to the fraud risk scenario as applied to a specified market segment;
converting the set of software-implemented risk factor objects into a rule set for application in one or more check cashing transactions, wherein the converting is performed using a second at least partially automated process; and
applying the at least one rule set during an analysis used to determine whether a check should be cashed.

9. The method of claim 8 wherein the set of software-implemented risk factor objects includes risk factor objects from a group of risk factor objects consisting of:
object to be considered;
category of object to be considered;
target associated with object to be considered;
importance of object to be considered;
process step;
primary actor; and
validation.

10. The method of claim 8 wherein the specified market segment includes at least one market segment from a group of market segments consisting of:
bank;
casino;
grocery store; and
retail.

11. A check cashing system, embodied, at least in part, in a computer-readable medium, the system comprising:
a first set of data elements representing transaction metadata or informational components including information derived from and associated with one or more images associated with a check to be cashed in a check cashing transaction, wherein the check is associated with a check cashing customer and a check maker;
a second set of data elements derived from characteristics of the transaction including information retrieved from the one or more images, information associated with the check cashing transaction, or both information retrieved from the one or more images and information associated with the check cashing transaction;
a methodologies component for performing rules-based analysis on the first set of data elements and the second set of data elements to calculate at least one score associated with the check; and
an auto-decisioning component for providing an output indicating whether or not the check should be cashed, wherein the auto-decisioning component provides the output based, at least in part, on an aggregate score, and wherein the auto-decisioning is not based on whether the check cashing customer has used the system previously to cash a previous check for a similar amount.

12. The system of claim 11 wherein:
the first set of data elements includes a variable number of types derived information types associated with graphical elements taken from the one or more images; and
the second set of data elements includes information associated with characteristics gathered from any one or more of a customer enrollment process, a check enrollment process, a pending transaction, one or more third-party databases, a fraud history associated with the check cashing customer, and a fraud history associated with the check maker.

13. The system of claim 11 wherein the rules-based analysis by the methodologies component includes the application of one or more rules from a group of rules consisting of:
value rules;
derived rules; and
composite rules based on combinations of the value rules and the derived rules.

14. The system of claim 11 wherein the rules-based analysis by the methodologies component includes the application of one or more rules to variables from a group of variables consisting of:
account status, check velocity, check amount variance, check frequency variance, check date variance, check amount threshold, maker amount threshold, courtesy and legal amount, payee recognition, signature verification, maker validation, magnetic ink check resolution data, header verification, check and vendor number, enhanced image analysis results, ID card type, social security number, date of birth, permanent address, death master list, third-party database variables, composite score, data range, account data freshness, customer level, and card activity.

15. The system of claim 11 wherein the rules-based analysis by the methodologies component includes the application of rules that act as multiple filters through which a transaction passes upon presentment of a check by a presenter, and wherein the filters include any one or more of a check amount threshold filter, a blocked maker filter, a data variance filter based on statistical analysis of historical performance, a new account filter based on several aspects of third-party validation of the presenter on first enrollment, a watch account filter, an amount variance filter, and a velocity filter.

16. The system of claim 11 further comprising:
a self-learning engine that facilitates an application, by the methodologies component, of past rules usage and transaction result records associated with analysis of checks during previously occurring transactions to the check cashing transaction.

17. The system of claim 11 wherein the rules-based analysis by the methodologies component includes analyzing pixels in the image of the check for deformation caused by copying or alteration.

18. The system of claim 11 wherein the rules-based analysis by the methodologies component includes analyzing the image obtained through scanning a paper stock on which the check is printed, wherein the analyzing includes determining whether alteration marks or voids exist in the paper stock for alteration.

19. The system of claim 11 wherein the rules-based analysis by the methodologies component includes integrating disparate third-party rules that represent fraud risk scenarios and translating the fraud risk scenarios into systematic rules for the purpose of assessing in real time transaction fraud risk.

20. The system of claim 11, further comprising:
a transaction history repository for storing new records associated with the check cashing transaction and past records associated with analysis of checks during previously occurring transactions, and wherein calculating the score includes scoring fields against the transaction history repository.

21. The system of claim 11, further comprising an administrative component for configuring and administering assisted workstations and automated transaction machines associated with the system, specifying the application of rules by the methodologies component, providing a user interface to a transaction repository associated with the system, maintaining user profiles associated with the system, and performing reports based on transactions, customers, and device status.

22. A system for facilitating the cashing of checks in a manner that reduces the cashing of potentially fraudulent checks, the system comprising:
means for capturing at least one image associated with a check to be cashed in a check cashing transaction, wherein the check to be cashed is issued by a check maker;
means for receiving transaction characteristics associated with the check cashing transaction;
means for extracting features and blocks of data from at least one document image associated with the check to be cashed;
means for verifying the existence of attributes from the at least one document image, including attributes associated with the extracted blocks of data;
means for generating and adapting a profile and a template for the check to be cashed, wherein the profile and the template facilitate further analysis of the check to determine whether the check should be cashed, and wherein the profile and the template are configured to facilitate cashing other checks issued from the check maker that issued the check; and
means for associating the generated template with a unique identifier, wherein the unique identifier is also associated with the check maker that issued the check.

23. The system of claim 22 wherein the means for capturing includes scanning components configured for scanning a front side and a back side of the check to be cashed.

24. The system of claim 22 wherein the transaction characteristics include information associated with at least one variable from a group of variables consisting of transaction amount, transaction date, transaction time, document date, customer information, location of presentment, device of presentment or check maker information, bank of maker information, transaction type, and document type.

25. The system of claim 22 wherein the extracted blocks data include one or more of a maker block, a logo block, an endorsement, a signature, watermark or security features, and a payee block.

26. The system of claim 22 wherein the attributes associated with the extracted blocks of data include one or more attributes obtained through feature extraction from a digitally obtained image, wherein the one or more attributes include:
signature, endorsement, notes, marks, annotations, courtesy amount recognition (CAR), and/or legal amount recognition (LAR).

27. A method for determining whether a transaction associated with a negotiable instrument should proceed, the method comprising:
applying rules to attributes of the negotiable instrument;
applying conditions against which no rule coverage is available; and
generating or suggesting new rules through self-learning, wherein the new rules are generated or suggested based on specific risk parameters.
